(19) United States
(12) Patent Application Publication
(10) Pub. No.: US 2002/0139550 A1
(43) Pub. Date: Oct. 3, 2002

(54) Diesel pile hammer

(76) Inventor: Stefan Mewes, Esslingen (DE)

Correspondence Address: FACTOR & PARTNERS, LLC, 1327 W. WASHINGTON BLVD., SUITE 5G/H, CHICAGO, IL, 60607, US

(21) Appl. No.: 10/113,013

(22) Filed: Mar. 29, 2002

(30) Foreign Application Priority Data
Mar. 29, 2001 (DE) 101 15 679.0

(51) Int. Cl. B25D 9/00

(52) U.S. Cl. 173/114

(57) ABSTRACT

In a diesel pile hammer, an end-piece that closes off the bottom end of the cylinder, in which a shaft section of an anvil is displaceably mounted, is provided with a lubricant collecting duct that leads to a lubricant collecting chamber separately fitted on the outside of the cylinder. In this way excess lubricant is taken away from the bottom end of the cylinder under control.

The invention relates to a diesel pile hammer as detailed in the preamble of claim 1.

Diesel pile hammers of this kind are used for example for driving concrete piles and sheet piles into the ground. The piston that runs in the cylinder and the anvil are subjected to powerful forces. To reduce the friction between these moving parts and the working surfaces of the cylinder that guide them, lubricant is fed to the working surfaces. There is provided for this purpose a lubricant pump that is connected to a plurality of lubricant output nozzles that are arranged at suitable points distributed over the working surfaces. The lubricant pump may be operated by a plunger for example, which is positively actuated by the piston when the latter moves in the cylinder.

If the metering of the lubricant is set to a low level, it may still happen that under unfavorable conditions the piston and anvil will move over the surface of the cylinder with high friction. If on the other hand the amount of lubricant is set such that it will be adequate even under unfavorable conditions, there is a risk that excess lubricant will escape from the cylinder and will be splashed about in the vicinity of the cylinder or will be burnt with the fuel, which causes more soot to be formed in the combustion gases.

The intention with the present invention is therefore to so refine a diesel pile hammer as detailed in the preamble of claim 1 that there is an assurance that excess lubricant from the cylinder will be conducted away.

This object is achieved in accordance with the invention by a diesel pile hammer having the features specified in claim 1.

In the diesel pile hammer according to the invention, the excess lubricant that collects at the bottom end of the cylinder is received by a collecting duct that leads to a lubricant collecting chamber provided at the bottom end of the cylinder. In this way, the excess lubricant can be conveniently disposed at intervals by an operator.

Advantageous refinements of the invention are specified in the sub-claims.

The refinement of the invention according to claim 2 gives a good seal at the point where the anvil passes through the bottom end of the cylinder.

When this is the case, the refinement of the invention according to claim 3 is of advantage in respect of easy assembly of the diesel pile hammer and, where necessary, of easy servicing of the seals that cooperate with the shaft section of the anvil.

In accordance with claim 3, the advantage is obtained that the lubricant connecting duct can be provided in a relatively small component of the diesel pile hammer, which makes machining easier. It is also possible in this way for the lubricant disposal system according to the invention to be easily retrofitted even to diesel pile hammers that are already in use.

The refinement of the invention according to claim 5 is also of advantage in respect of making the lubricant connecting duct easy to produce.

In a diesel pile hammer according to claim 6 the lubricant collecting chamber is particularly easy of access.

According to claim 7, the lubricant collecting chamber that is provided in accordance with the invention may also be used to collect the moisture and condensates that are produced when the combustion gases are cleaned, at an easily accessible point.

At the same time it is ensured in a diesel pile hammer according to claim 8 that the combustion air is drawn in directly from the surroundings of the cylinder and not via the liquid separator that removes the liquid and condensate from the combustion gases.

The changeover device that brings together the flow-path for combustion air and the flow-path for combustion gases in the working passage of the cylinder has particularly good flow characteristics for the combustion gases when configured in accordance with claim 9.

At the same time, the refinement of the invention according to claim 10 ensures that the combustion gases are fed to the liquid separator in their entirety and do not make their way directly into the surroundings at as early a point as the flow changeover device. If the flow changeover device is of the form specified in claim 10 it will be more a question of fresh air being drawn in by a water-jet effect at the gap between the bell-shaped tubular part and the cylinder of the diesel pile hammer than of combustion gases escaping through this gap.

The refinement of the invention according to claim 11 is also of advantage, in respect of suppressing any drawing-in of combustion air through the liquid separator.

If there is also provided for the diesel pile hammer a further separator that is used mainly to separate out solid particles and if this further separator also has a sump section in which any residual amounts of liquid and condensate that are still present in the combustion gases collect, then it is possible in accordance with claim 12 for these residual amounts too to be disposed of simply at an easily accessible point.

When this is the case, it is ensured by the refinement of the invention according to claim 13 that the amount of residual liquid and residual condensate that occurs in the solids separator is small.

### BRIEF DESCRIPTION OF THE DRAWINGS

The invention will be explained in detail below by reference to embodiments and to the drawings. In the drawings:

FIG. 1 is a side view of a diesel pile hammer having a means for cleaning the combustion gases,

FIG. 2 is an enlarged view in axial section of the bottom section of the diesel pile hammer shown in FIG. 1, in the phase where the combustion gases are expelled,

FIG. 3 is a view similar to FIG. 2 showing the conditions on the intake stroke of the diesel pile hammer,

FIG. 4 is a schematic perspective view of a first separator of the diesel pile hammer shown in FIG. 1, which is used for separating out liquid and/or condensable components of the combustion gases, and

FIG. 5 is a schematic perspective view of a second separator of the diesel pile hammer shown in FIG. 1, which is used to separate out soot particles and other solid components contained in the combustion gases.

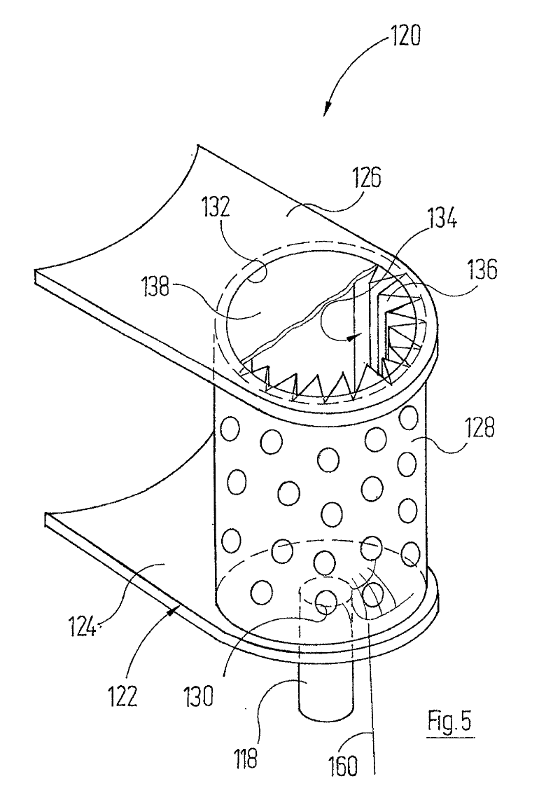

### DETAILED DESCRIPTION OF THE DRAWINGS

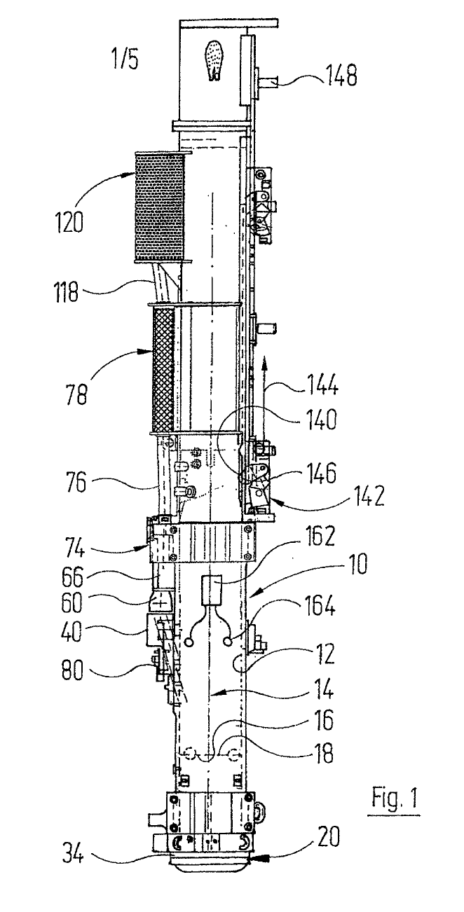

The diesel pile hammer shown in FIG. 1 has a cylinder referred to generally as 10 that has a working surface 12. Movable within the cylinder 10 is a piston 14 that is only indicated in broken lines in FIG. 1. Piston 14 is shown in FIG. 1 in a down position in which a bottom end-face 16 of piston 14 is just resting against a top end-face 18 of an anvil 20.

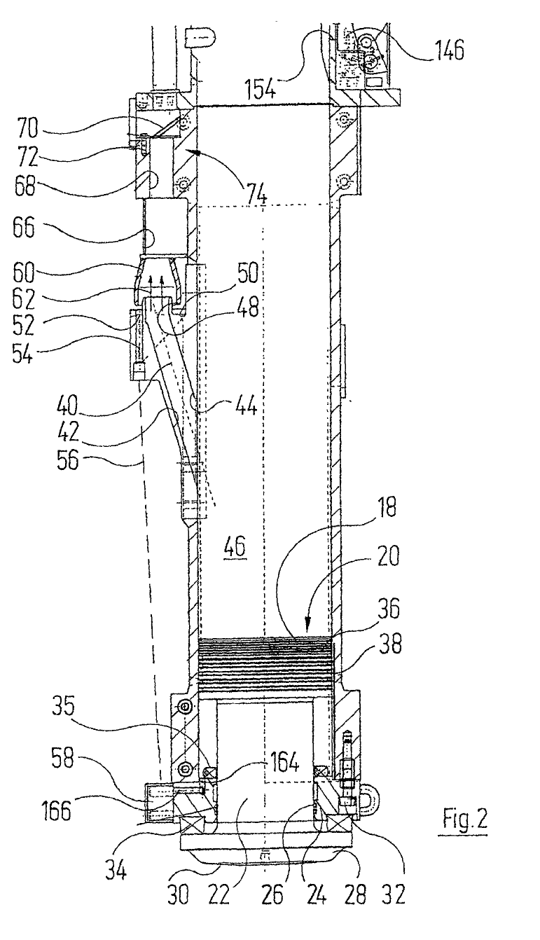

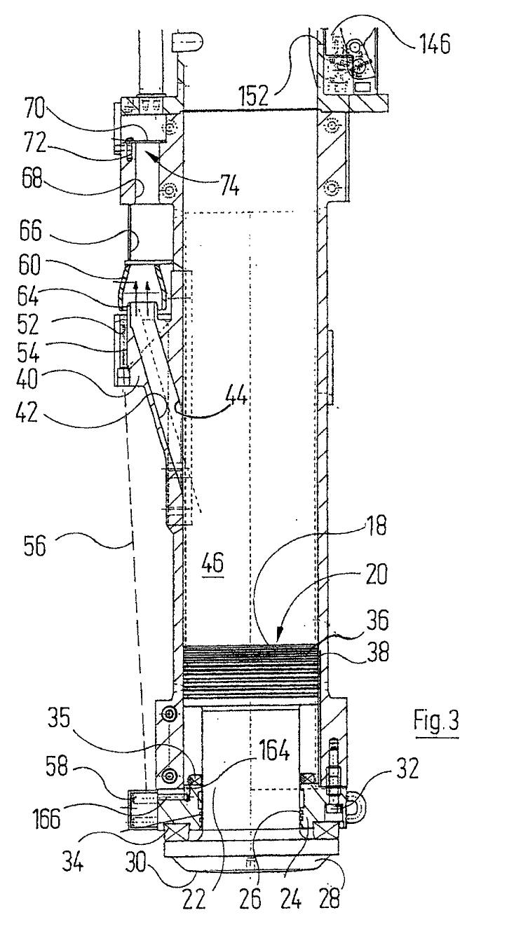

As can be seen from FIGS. 2 and 3, the anvil 20 has a central shaft section 22 which is guided in a sleeve-like end-piece 24 of the cylinder and which is sealed against the inside of the latter by seals 26.

A bottom head-section 28 of anvil 20 has a curved bottom end-face 30 that, either directly or via a cushion head (not shown) cooperates with the top end of an item to be driven (e.g. a sheet pile or a concrete pile).

The cylinder end-piece 24 is connected to the bottom end of cylinder 10 by bolts 32. A damping ring 34 is provided between the opposing end-faces of cylinder end-piece 24 and the head section 28 of the anvil 20.

A further damping ring 35 comes into action when the bottom face of a piston section 36 of the anvil 20 is moved towards the top face of the end-piece 24 of the cylinder.

The piston section 36 at the top of the anvil 20 carries a plurality of sealing rings that succeed one another in the axial direction and that cooperate with the working surface 12.

Provided in a lateral projection 40 on cylinder 10 is a working passage 42 that is inclined at an angle of approximately 17ø to the axis of cylinder 10. The end of working passage 42 that is situated in working surface 12 forms a working port by which, in conjunction with the bottom end of piston 14, access to a working chamber 46 in the diesel pile hammer is controlled, which chamber is defined by piston 12, anvil 20 and working surface 12.

A top section 48 of working passage 42 projects upwards from projection 40 from the cylinder in a sleeve-like form, parallel to the axis of cylinder 10.

Provided in the top face of the projection 40 from the cylinder is an annular channel 50 that surrounds section 48 of the passage. This channel 50 is connected to a drain bore 52 that can be closed off by a drain screw 54 (as shown) or that can be connected via a fitting to a drain line 56 (shown in broken lines) that leads to a collecting chamber 58 for liquid that is provided at the bottom end of cylinder 10.

The sleeve-like cylindrical section 48 of the passage is also surrounded coaxially by a bell-like, frustoconical tubular part 60 that overlaps section 48 of the passage axially, though there is an interstice left between the outer face of section 48 of the passage and the inner face of tubular part 60 and between the bottom edge of tubular part 60 and the top face of projection 40 from the cylinder. The diameter of the top section of tubular part 60 is substantially the same as the diameter of section 48 of the passage.

In the compression phase of the two-stroke diesel engine formed by cylinder 10 and piston 14, combustion gases flow out through working passage 42 and into the interior of tubular part 60, as indicated by arrows 62.

In the intake phase of the diesel pile hammer on the other hand combustion air flows through the gap defined by section 48 of the passage and tubular part 60, as indicated by arrows 64 in FIG.3.

The combustion gases 62 are directed by tubular part 60 into a buffer chamber 66 that is separately fitted to the outer face of cylinder 10. From there, the combustion gases pass through a valve passage 68 to a flap-valve member 70 that is formed in the present case by a valve-tongue held by a screw 72. It could however also be a rigid flap with a hinged joint.

From the check valve 74 formed by valve passage 68 and flap-valve member 70, the combustion gases pass via a duct 76 to a first separator that is referred to generally as 78, in which liquid and condensable components are extracted from the combustion gases.

Two sets of the components 40-76 described above are provided on cylinder 10 with a 90ø offset between them in order to ensure that there are adequate inflow and outflow cross-sections for working chamber 46.

In line with this, an injector unit 80 that is only schematically indicated in FIG. 1 can emit jets of fuel from two injection nozzles that are offset from one another by 180° or 90° in the circumferential direction, as is known per se.

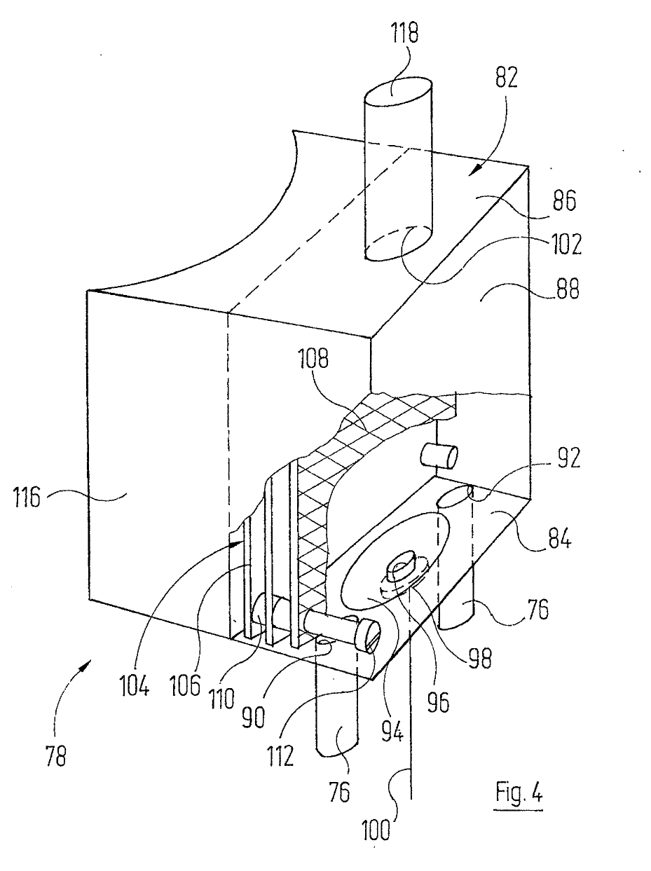

As can be seen from FIG. 4, the first separator 78 has a casing referred to generally as 82 having a bottom wall 84, a top wall 86 and a circumferential wall 88 of rectangular cross-section situated therebetween.

Provided in bottom wall 84 are two connecting openings 90, 92 that connect up with the two ducts 76. The connecting openings 90, 92 are situated at the extreme left-hand and extreme right-hand edges respectively of bottom wall 84. Between connecting openings 90, 92, there is a depressed section 94 of bottom wall 84 that extends downwards in a conical shape and that is connected to a drain opening 96 for the liquid and condensate that are separated out.

The drain opening 96 may be closed off by a screw 98, that is removed at intervals to allow the contents of the sump formed by the depressed section of wall to be drained off. Alternatively, the drain opening 96 may, as indicated in broken lines, be connected by a duct 100 to the collecting chamber 58 for liquid that is provided at the bottom end of cylinder 10.

The top wall 86 of separator casing 82 has a single outlet opening 102 for combustion gases.

Arranged in the interior of separator casing 82, which is substantially in the form of a right parallelepiped, is a stack, referred to generally as 104, of separating plates 106. The separating plates 106 are each made of ribbed interwoven metal mesh, as indicated by some of the apertures that are shown by way of illustration at 108. The apertures 108 in the mesh are diamond-shaped and are so aligned that their long diagonal is parallel to the axis of the cylinder, which in operation is substantially coincident with the vertical.

In practice, the separating plates 106 of ribbed interwoven metal mesh have apertures whose maximum length is between 10 and 30 mm and preferably between 15 and 22 mm, whereas the minor axis of the apertures is between 5 and 15 mm and preferably between 8 and 10 mm. The width of the divisions between the apertures is between 1 and 3 mm and is preferably approximately 1.5 mm. The thickness of the divisions is between approximately 0.5 and approximately 2 mm and preferably between 1 and 1.5 mm. The overall thickness of an individual separating plate is in the range between approximately 1 and 5 mm and preferably between 2 and 3 mm. In practice, the spacing between separating plates 106 arranged next to one another in parallel is approximately 3 to 15 mm and preferably approximately 8 to 12 mm.

The individual separating plates 106 are spaced apart by suitable spacer sleeves 110 that are inserted between adjacent separating plates 106 and through which extend studs 112 by which the separating plates 106 are assembled into a stack of plates 104 that can be handled as a single unit.

If desired, as a modification of the embodiment shown in the drawing, the separating plates may be provided with a corrugation that is larger than the spacing between the plates, thus giving even more intimate contact between the combustion gases and the surfaces of the separating plates.

However, because the connecting openings 90, 192 are offset laterally from the outlet opening 102, even when the geometry of the separating plates 106 is flat a flow component is obtained in a direction perpendicular to the plane of the separating plates 106.

The separator casing 82 is joined to a fuel tank 116 in such a way that what is obtained is a smooth-faced external contour. The inward face of the fuel tank 116 is matched to the curvature of the outside face of cylinder 10, as can be seen from FIG. 4.

The outlet opening 102 from the first separator 78 is connected via a duct 118 to a second separator 120 that filters soot and other solid components out of the combustion gases.

Separator 120 has a casing that is referred to generally as 122 and that has a bottom end-wall 124 that is connected to the outlet end of duct 118, a top end-wall 116 and a circumferential wall 128 lying therebetween. Provided in circumferential wall 128 are a large number of circular openings 130. The top end-wall 126 has a large opening 132.

Housed in the interior of casing 122 is a filter element referred to generally as 134. The latter has a circumferential wall 136 folded in a zigzag pattern that is composed of a woven plastics fabric that is provided with a coating of porous plastics material. The pores in filter element 134 are selected to be such that 95% of the particles that have a diameter of 0.4 μm or more will be removed from a flow of gas passing through the filter material.

The circumferential wall 136 formed by the filter material folded in a zigzag pattern is closed off at the top end by a wall of paper 138 or the like that is impermeable to gas.

The diameter of opening 132 is selected to be slightly smaller than the outside diameter of filter element 134 so that the filter element 134 can, by being compressed, be moved through opening 132 but in the unstressed state is retained in the casing 122 by the edge of opening 130. Combustion gases containing soot and other solid particles then impinge on the interior of filter element 134 from the end of duct 118 and then pass through the circumferential wall 136 of filter element 134 (and subsequently through the circumferential wall 128 of casing 122) in the radial direction and as they do so leave behind the solid components contained in them.

Due to the severe shock loads to which the diesel pile hammer is subject in active operation, the filter element 134 is shaken powerfully and as a result particles that are separated out on the inside of the element drop off and collect across the bottom end-wall 124 of casing 122. From there the solid components that have been separated out can be taken away at intervals, where appropriate at the same time as the filter element 134 is replaced, as it has to be anyway at fairly long intervals.

Separators 78 and 120 are arranged one above the other in line axially on the outside of cylinder 10.

In FIG. 1, there is shown at 140 a shoulder 140 on the piston 14 by which the piston 12 is taken hold of to allow the diesel pile hammer to be started and is lifted up by a mechanical starting device. This mechanical starting device comprises a coupling head 142 that can be displaced in the vertical direction by a drive means indicated by an arrow 144, e.g. a wire rope or a hydraulic lifting cylinder.

The drive head 142 comprises a pawl 146 able to pivot about a horizontal axis that cooperates with shoulder 140 and that can be moved from the working position shown in the drawing to a freed position in which the piston 14 is released and for which provision is made at a preset height on cylinder 10.

If desired, it is also possible for there to be provided on cylinder 10 a movable stop 150 (see FIG. 6) that can be connected as desired to different fixing holes 152 in cylinder 10 to enable the height of drop of piston 14 when starting to be made smaller than that preset by stop 148 to suit the soil conditions at the time.

To enable pawl 146 to carry shoulder 140 along with it, cylinder 10 has a suitable longitudinal slot 154 parallel to its axis (see FIGS. 2, 3 and 6).

The diesel pile hammer described above operates as follows:

Fuel injected into working chamber 46 having been ignited when piston 14 struck the top face of anvil 20, piston 14 is thrust upwards. Combustion gases first flow out via working passage 42, tubular part 60 and buffer chamber 66 and via check valve 74 into first separator 78. There the combustion gases flow along the surfaces of separating plates 106 and as they do so they lose the liquid and condensable components contained in them.

Having been freed of their liquid and condensable components, the combustion gases flow via duct 118 into the second separator. The combustion gases flow into filter element 134 axially and then change their direction of flow, because filter element 134 is closed off at the top by the wall of paper 138, and flow through the circumferential wall 136 of filter element 134, that is folded in a zigzag pattern, in the radial direction. Soot particles and other particles of solid matter contained in the combustion gases are then retained as the gases do so.

Due to its kinetic energy, piston 14 continues to rise in cylinder 10 even when the pressure in working chamber 46 has already dropped to atmospheric pressure. In the course of this continuing upward movement of piston 14, a pressure below atmospheric is then generated in working chamber 46 and ambient air is drawn in through the throttling gap defined by tubular part 60 and section 48 of working passage 42. Because of the pressure below atmospheric generated in working passage 42, flap-valve member 70 is then moved to the closed position, as shown in FIG. 3.

The drawing in of combustion air comes to an end as piston 14 reaches its top dead center.

As piston 14 then drops down, working port 44 is closed off by the circumferential surface of the piston and as from this point on the downstroke the air in working chamber 46 is compressed, in the course of which it heats up. As the piston 14 continues to fall, injection unit 80 is actuated and a preset amount of fuel is sprayed onto the top end-face of anvil 20.

When piston 14 strikes the top end-face 18 of anvil 20, it surrenders its kinetic energy to anvil 20. The latter is forced down in this way and in turn drives the item to be driven with which it co-operates into the ground.

At the same time as piston 14 strikes anvil 20 the fuel situated on the latter is ignited and the cycle described above is repeated.

From the above description it can be seen that the diesel pile hammers according to the invention can continue to operate as two-stroke diesel engines but it is possible nevertheless for the combustion gases to be cleaned. The liquid and condensable components are removed from the gases in separator 78 and the solid components, and particularly soot particles, are removed in separator 120.

In this case tubular part 60, passage section 48 and check valve 74 together form a unit that ensures that combustion air is fed to working chamber 46 straight from the ambient atmosphere, whereas combustion gases are only released into the surroundings when they have first passed through separators 78 and 120.

The exhaust gas means provided in accordance with the invention for a diesel pile hammer is of simple mechanical construction and is sufficiently rugged to withstand the shock loads that occur when a diesel pile hammer is operating, even in long-term operation. The exhaust gas cleaning means is easy to maintain and is easy to clean too when required. It is compact in construction and enlarges the clear dimensions of the diesel pile hammer only slightly.

The following further modifications may be made:

The bottom end-wall 124 of the casing 122 of the separator 120 for solid components of the combustion gases may contain a depression that is connected to a drain opening to enable any residual liquid components that may arise in separator 120 to be drained off.

This drain opening may be connected in turn, via a drain duct 160, to the collecting chamber 58 that is situated at the bottom end of cylinder 10.

Working slot 44 may be connected to the ambient atmosphere by a fresh-air valve situated upstream of exhaust gas valve 74, in which case the fresh-air valve may be a flap valve or a disk valve whose closure member is preloaded to the closed position by weight and/by resilient force.

Lubricant is fed via lubricant nozzles 164 to various points on the working surface 12 of the cylinder by a lubricant pump 162. The lubricant is distributed by the movement of piston 14 and anvil 20.

Excess lubricant is acted on by gravity and runs onto the top face of the end-piece 24 of the cylinder. Running from there is a lubricant collecting passage that has a vertical section 164, and a radial section 166 that opens into the liquid collecting chamber 58.

In this way all the liquids that arise in the diesel pile hammer and have to be disposed of are made available at a single, easily accessible point.

What is claimed is:

1. A diesel pile hammer having a cylinder having a working opening, a piston running in the cylinder and an anvil that is guided in the bottom end of the cylinder, having a means for injecting fuel into the interior of the cylinder and having a means for feeding lubricant to the working surfaces of the cylinder, characterized in that from the bottom end of the cylinder runs a lubricant collecting duct that leads to a lubricant collecting chamber carried by the bottom end of the cylinder.

2. The diesel pile hammer according to claim 1, characterized in that the anvil has a central shaft section that cooperates with sealing means secured to the cylinder.

3. The diesel pile hammer according to claim 2, characterized in that the sealing means are carried by a cylinder end-piece that is preferably detachably connected to the bottom end of the cylinder.

4. The diesel pile hammer according to claim 3, characterized in that the lubricant collecting duct is formed in the cylinder end-piece.

5. The diesel pile hammer according to claim 1, characterized in that the lubricant collecting duct has a first section with an axial component of extension that is connected to the interior of the cylinder and a second section with a radial component of extension that is connected to the lubricant collecting chamber.

6. The diesel pile hammer according to claim 1, characterized in that the lubricant collecting chamber is separately fitted to the outside of the cylinder.

7. The diesel pile hammer according to claim 1, characterized in that the lubricant collecting chamber is connected via a second collecting duct to a sump section of a liquid separator that is connected to the working openings in the cylinder.

8. The diesel pile hammer according to claim 7, characterized in that the liquid separator is connected to the working openings in the cylinder via a flow changeover device.

9. The diesel pile hammer according to claim 8, characterized in that the flow changeover device has a tubular part that is spaced away from the free end of a working passage communicating with the working opening but that otherwise constitutes a continuation of the working passage in terms of flow.

10. The diesel pile hammer according to claim 9, characterized in that the tubular part widens in a substantially conical shape in the direction of the end of the working passage and surrounds the free end of the working passage radially.

11. The diesel pile hammer according to claim 8, characterized in that the flow changeover device is connected to the liquid separator via a check valve.

12. The diesel pile hammer according to claim 1, characterized in that the lubricant collecting chamber is connected via a third collecting duct to a sump section of a particle separator.

13. The diesel pile hammer according to claim 12, characterized in that in terms of flow the particle separator is connected downstream of the liquid separator and the liquid separator is connected to the working openings in the cylinder via a flow changeover device.
